(19) United States
(12) Patent Application Publication
(10) Pub. No.: US 2017/0231376 A1
(43) Pub. Date: Aug. 17, 2017

(54) Cook Hook

(71) Applicants: Julio Roberto Mendez, Pinellas Park, FL (US); Jessica Isabel Mendez, Pinellas Park, FL (US)

(72) Inventors: Julio Roberto Mendez, Pinellas Park, FL (US); Jessica Isabel Mendez, Pinellas Park, FL (US)

(21) Appl. No.: 15/045,352

(22) Filed: Feb. 17, 2016

(51) Int. Cl. A45F 5/02; A47J 45/00

(52) U.S. Cl. CPC A45F 5/021; A47J 45/00

(57) ABSTRACT

A curved waist holder having a parallel and integral neck is attached to an intermediate arm disposed perpendicularly thereto and is also integrally attached to a tong engagement portion. This has a downwardly directed internal grip arm attached further with a rest arm that attaches to an upwardly directed external grip arm.

### FIELD OF THE INVENTION

The present invention relates to a device for holding kitchen implements; more particularly, the present invention relates to an article of manufacture that holds a tong.

### BACKGROUND OF THE INVENTION

A tong is a device used in a home or commercial kitchen for grasping items for insertion or removal from a basin, pan, bowl, plate or similar cooking or eating device. Typically, a tong is most generally constructed of two arms attached together at a pivot point utilizing a pin, hinge or similar axial member.

Each arm of the tong is linearly disposed such that each ends at an oval or round concave portion forming a half mouth; together these two oval or round concave portions at both ends form a mouth thereby for gripping or grasping items. In order for the device to be ready for a user to engage items within the mouth thereof, a coiled spring or similar mechanism is used to separate the two arms thereby maintaining the mouth of the tong open for a user.

Thus, since a tong is reset by the spring mechanism after each activity, a user can reach out towards a food item and close the tong mouth at the end of each arm and grasp the aforementioned item. Then he or she places that item on another cooking or eating device; once this happens the user releases the tong and it resets to its previous open state. The repetitive closing to grip an item and subsequent release by a user permits the system to return to its steady state.

However, a problem arises in that in between uses, one needs to place the tong in a convenient location so as perform some other kitchen cooking activity. Mixing items, stirring, using electronic devices, chopping, cleaning a countertop or preparing other dishes, all require time and the tong must rest somewhere during that time interval. Typically, a user places that item on a countertop or other place and goes on to other work.

But this has the deficiency in that the tong is one of the most used items in the kitchen and by laying it aside somewhere else the user increases lag time for its next successful use. That is, it takes time to relocate the tong from where it was recently laid aside and it typically gets placed around the kitchen or cooking area where it may not be easily locatable.

Accordingly, there needs to be some solution to overcome the aforementioned problems.

### SUMMARY OF THE INVENTION

The present invention overcomes the deficiencies of the known art and the problems that remain unsolved by providing a tong holder according to the following.

A tong holder device comprising:

a waist attachment portion integrally attached to

a tong holding portion.

In another aspect, wherein the waist attachment portion further comprises:

a waist arm.

In another aspect, wherein the waist attachment portion further comprises:

a waist holding portion integrally formed from the waist arm.

In another aspect, wherein the waist holding portion further comprises: a waist holding portion that is larger than the waist arm.
In another aspect, wherein the waist holding portion further comprises: a curved waist holding portion.
In another aspect, wherein the waist attachment portion further comprises:

a waist holding portion.

In another aspect, wherein the waist attachment portion further comprises:

a waist arm integrally formed from the waist holding portion wherein the waist arm protrudes outwards therefrom and where the waist arm is integrally formed with the tong holding portion.

In another aspect, wherein the waist holding portion further comprises: a waist holding portion that is larger than the waist arm.
In another aspect, wherein the waist holding portion further comprises: a curved waist holding portion.
In another aspect, wherein the tong holding portion further comprises:

a rest arm integrally formed from the waist attachment portion.

In another aspect, wherein the tong holding portion further comprises:

an internal grip arm integrally attached to the waist attachment portion.

In another aspect, wherein the tong holding portion further comprises:

an external grip arm integrally attached to the waist attachment portion.

In another aspect, wherein the tong holding portion further comprises:

an internal grip arm integrally attached to the rest arm and the waist attachment portion.

In another aspect, wherein the tong holding portion further comprises:

an external grip arm integrally attached to the rest arm and the waist attachment portion wherein the rest arm is integrally disposed between the internal and external grip arms.

A cooking implement carrier comprising:

a cooking implement support device attached to

a clothing engagement device.

In another aspect, wherein the clothing engagement device further comprises:

a rounded clothing engagement device integrally formed with a neck thereof that is further attached to the cooking implement support device.

In another aspect, wherein the cooking implement support device further comprises:

an intermediate device integrally attached to both the neck of the rounded clothing engagement device and the cooking implement support device.

In another aspect, wherein the cooking implement support device further comprises:

an downwardly disposed internal arm integrally attached to the intermediate device.

In another aspect, wherein the cooking implement support device further comprises:

an upwardly disposed external arm integrally attached to the downwardly disposed internal arm through a rest arm there between.

A tong holder comprising:

a curved waist holder having
a parallel and integral neck attached to

an intermediate arm disposed perpendicularly thereto also integrally attached to

a tong engagement portion having
a downwardly directed internal grip arm attached further with
   a rest arm that attaches to
an upwardly directed external grip arm.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a tong holder according to an exemplary embodiment as taught herein.

FIG. 2 presents a user engaging the tong holder on his waist according to an exemplary embodiment as taught herein.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

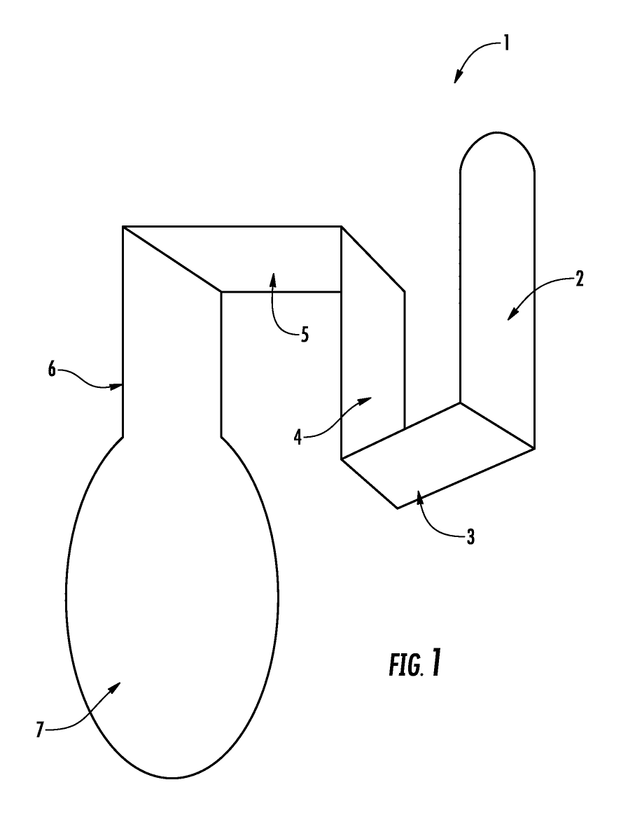

FIG. 1 presents a tong holder according to an exemplary embodiment as taught herein. The tong holder 1 has several components as described herein and comprises a single integral piece of metal, plastic or similar material. The device is formed from portions of the integral material forming five flat arms and a waist device: an external grip arm 2, a resting arm 3, an internal grip arm 4, an intermediate arm 5, a waist arm 6 as well as a waist holding portion 7 integrally formed as described below.

The external grip arm 2, as its name implies is designed to sit externally, parallel to and away from the body of the user. In contradistinction, the waist holding portion 7 is inserted behind a pants or skirt line or belt and thusly, the external grip arm 2 is disposed externally and away from the user. Working inwards towards the waist holding portion 7 from the external grip arm 2, there is firstly a resting arm 3 integrally formed from an edge of the external grip arm 2 and at perpendicular angle therefrom. It is at the resting arm 3 where a user would place the narrow axial or end portion of the tong so that it can rest thereon and the user can move about the kitchen or serving area using and reusing the item.

Next, integrally formed from the other edge of the resting arm 3 is an internal grip arm 4. This internal grip arm 4 shields the user pants, clothing, belt from receiving bumps from the tong placed on the resting arm 3. The internal grip arm is disposed parallel to the external grip arm 2 and therefore designed to be parallel to the body of the user. Thus, it should be understood that the combination of external grip arm 2, resting arm 3 and internal grip arm 4 is the section of the device that is considered the ‘tong engagement portion’ whilst the resting arm 3 is where the tong directly rests thereon.

At this point the device proceeds further inwards towards the user. Thus, another integrally shaped piece, an intermediate arm 5, begins from an opposite end of the internal grip arm 4 end used to attach the internal grip arm 4 to the resting arm 3. This intermediate arm 5, is parallel to the resting arm 3 and thereby perpendicular to the body of the user; its other end is integrally attached to one end of a waist arm 6. This waist arm 6 is designed to be worn downwards and parallel to the body of a user and to both the internal grip arm 4 and external grip arm 2.

The waist arm 6 has its other end integrally attached to a waist holding portion 7 that is designed to be inserted behind a pants, skirt or belt and thereby support the entire tong holder device 1 on the user body. The waist holding portion 7 is wider than any of the arms 2, 3, 4, 5, 6 and round or oval so as to provide a broad surface so that when the device is employed for the purposes described herein it can resist sliding out from behind the pants, skirt or belt. Similar to the waist arm 6, the waist holding portion 7 is directed downwards and parallel to the body of a user and to both the internal grip arm 4 and external grip arm 2 and perpendicular to the intermediate arm 5 and the resting arm 3.

It should be understood that the terms perpendicular or parallel thereto are most broadly understood as what is generally practicable in the design and construction of said device. Therefore, deviations from a perfect ‘X’ degree angle are expected in the final manufacture as are those with regards to the parallel or perpendicular nature of the arms described herein. Similarly, the integral edge connection whilst described as being sharp edges these are optionally rounded for a more easily constructed device. What is most broadly described herein is a device having several arms that proceed with a first arm 2 downwards then another second arm 3 inwards, followed by a third arm 4 back upwards, a fourth arm 5 further inwards and a fifth arm 6 downwards again followed by a final broad device 7 all integrally formed from a single piece of metal or plastic material.

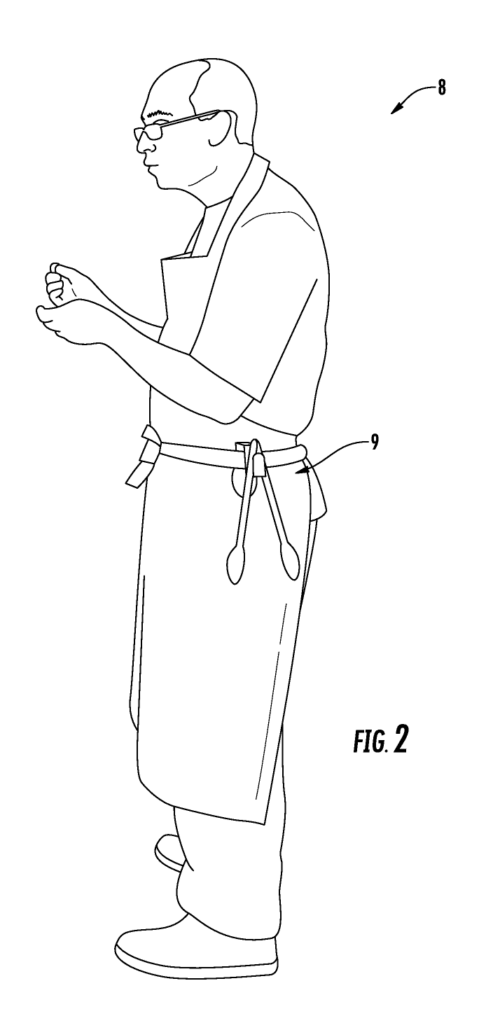

FIG. 2 presents a user engaging the tong holder on his waist according to an exemplary embodiment as taught herein. The final broad device or waist holding portion 7 is inserted behind the waist edge of a pair of pants of a user for placement of a tong on the tong holder 1.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. A tong holder device comprising:
a waist attachment portion integrally attached to
a tong holding portion.

2. The tong holder device of claim 1, wherein the waist attachment portion further comprises:
a waist arm.

3. The tong holder device of claim 2, wherein the waist attachment portion further comprises:
a waist holding portion integrally formed from the waist arm.

4. The tong holder device of claim 3, wherein the waist holding portion further comprises: a waist holding portion that is larger than the waist arm.

5. The tong holder device of claim 3, wherein the waist holding portion further comprises: a curved waist holding portion.

6. The tong holder device of claim 1, wherein the waist attachment portion further comprises:
a waist holding portion.

7. The tong holder device of claim 6, wherein the waist attachment portion further comprises:
a waist arm integrally formed from the waist holding portion wherein the waist arm protrudes outwards therefrom and where the waist arm is integrally formed with the tong holding portion.

8. The tong holder device of claim 7, wherein the waist holding portion further comprises: a waist holding portion that is larger than the waist arm.

9. The tong holder device of claim 6, wherein the waist holding portion further comprises: a curved waist holding portion.

10. The tong holder device of claim 1, wherein the tong holding portion further comprises:
a rest arm integrally formed from the waist attachment portion.

11. The tong holder device of claim 1, wherein the tong holding portion further comprises:
an internal grip arm integrally attached to the waist attachment portion.

12. The tong holder device of claim 1, wherein the tong holding portion further comprises:
an external grip arm integrally attached to the waist attachment portion.

13. The tong holder device of claim 10, wherein the tong holding portion further comprises:
an internal grip arm integrally attached to the rest arm and the waist attachment portion.

14. The tong holder device of claim 13, wherein the tong holding portion further comprises:
an external grip arm integrally attached to the rest arm and the waist attachment portion wherein the rest arm is integrally disposed between the internal and external grip arms.

15. A cooking implement carrier comprising:
a cooking implement support device attached to
a clothing engagement device.

16. The cooking implement carrier of claim 15, wherein the clothing engagement device further comprises:
a rounded clothing engagement device integrally formed with a neck thereof that is further attached to the cooking implement support device.

17. The cooking implement carrier of claim 16, wherein the cooking implement support device further comprises:
an intermediate device integrally attached to both the neck of the rounded clothing engagement device and the cooking implement support device.

18. The cooking implement carrier of claim 17, wherein the cooking implement support device further comprises:
an downwardly disposed internal arm integrally attached to the intermediate device.

19. The cooking implement carrier of claim 18, wherein the cooking implement support device further comprises:
an upwardly disposed external arm integrally attached to the downwardly disposed internal arm through a rest arm there between.

20. A tong holder comprising:
a curved waist holder having
a parallel and integral neck attached to
an intermediate arm disposed perpendicularly thereto also integrally attached to
a tong engagement portion having
a downwardly directed internal grip arm attached further with
a rest arm that attaches to
an upwardly directed external grip arm.
